(19) United States
(12) Patent Application Publication
(10) Pub. No.: US 2009/0066499 A1
(43) Pub. Date: Mar. 12, 2009

(54) EXTERNAL SOUND GENERATING SYSTEM AND METHOD

(75) Inventors: Yun Bai, Santa Clara, CA (US); Everett Meyer, Palo Alto, CA (US)

Correspondence Address: DLA PIPER LLP (US ), 2000 UNIVERSITY AVENUE, EAST PALO ALTO, CA, 94303-2248, US

(73) Assignee: Enhanced Vehicle Acoustics, Inc., Santa Clara, CA (US)

(21) Appl. No.: 12/166,280

(22) Filed: Jul. 1, 2008

Related U.S. Application Data
(60) Provisional application No. 60/950,116, filed on Jul. 17, 2007.
(60) Provisional application No. 61/028,514, filed on Feb. 13, 2008.

(51) Int. Cl. B60Q 1/00

(52) U.S. Cl. 340/459

(57) ABSTRACT

An external sound generating system and method are provided that can be used to generate an external sound for quiet vehicles such as hybrid vehicle, an electric motor vehicle or a fuel cell vehicle.

### PRIORITY CLAIM/RELATED APPLICATIONS

This applications claims the benefit, under 35 USC 119(e) to U.S. Provisional Patent Application Ser. Nos. 60/950,116 filed on Jul. 17, 2007 and 61/028,514 filed on Feb. 13, 2008, both of which are incorporated herein in their entirety by reference.

### FIELD

The system and method relate generally to a sound emitting system for vehicles.

### BACKGROUND

Technological innovation makes vehicles such as hybrid, electric motor and fuel cell vehicles very quiet on the road. This creates a need for an external sound emitting system that will provide acoustic cues to animals, pedestrians, cyclists and other groups about the direction and intention of vehicles. This will likely prevent accidents or unwanted outcomes such as leaving the vehicle on without realizing it. Also, individuals can determine the basic sound identify of their vehicle. It is desirable to provide a system and method that allows the intelligent generation of sound for safety and general awareness while likely reducing noise pollution and allowing individuals to generate their own sound identity within certain confines established by such things as scientific testing, public opinion and government regulations.

### BRIEF DESCRIPTION OF THE DRAWINGS

FIG. 1 is a schematic diagram of an implementation of a sound emitting system;

FIG. 2 is a diagram of a multiaxial accelerometer with output to SPU and/or multiple speaker system that can be used with the sound emitting system shown in FIG. 1;

FIG. 3 is a diagram of an example of the user interface and sound processor unit (SPU) of the sound emitting system shown in FIG. 1;

FIG. 4 is a depiction of the multiple speaker system, including 4-point speaker distribution;

FIG. 5 is a diagram of the remote driver display;

FIG. 6 is a diagram of the ultrasonic emission component subsystem; and

FIG. 7 illustrates another embodiment of the system.

### DETAILED DESCRIPTION OF ONE OR MORE EMBODIMENTS

The system and method are particularly applicable to a system and method for generating sounds for quiet vehicles such as hybrids, electric motor and fuel cell vehicles and it is in this context that the system and method will be described. It will be appreciated, however, that the system and method has greater utility since it can be used with any vehicle, such as for example, bicycles, electric motorcycles, mopeds, scooters and the like in which it is desirable to generate sounds for the vehicle.

The sound generating system does not necessarily depend upon the mechanical generation of sound through fans, whistles or other non-electric speaker devices. In addition, the system and method is not limited to industrial electric cars. The system and method may be linked with a system for providing feedback to a driver, however, the purpose of the system also pertains to the emission of acoustic cues to beings around the vehicle. The system and method provide protected interchangeable sound elements installed through a user interface and may allow the vehicle's driver or technician to customize the sounds that are conveyed. The system can be used to generate alarm or acoustic warning sounds, but may also provide acoustic cues related to vehicle motion and intent as well. The system can integrate information from the motor vehicle computer or components, and from its own sensors, to more effectively collect and convey vehicle status and driver intent. The system allows for the directional emission of sound based upon vehicle movement, and intent to move or stay stationary, and therefore will likely generate less noise pollution and will likely provide better acoustic cues.

The system also allows for the emission of sound based upon sensors of ambient conditions and therefore will likely generate less noise pollution and will likely provide better acoustic cues. The system also allows for the emission of sounds more effectively noticed by animals (such as high-frequency sounds) or special groups of human beings such as children. The system also allows for the more facile emission of sounds better suited for certain geographies or conditions or cultures. The system may also stop emitting sounds when the vehicle speeds and ambient air noise generated off the vehicle body or other components does not necessitate sound emission (for example, at speeds >25 mph or other set points). The system may also include the possibility of a speaker or communication component of the system carried by the driver which can convey the status and condition of the system and/or vehicle to the vehicles owner or operator remotely.

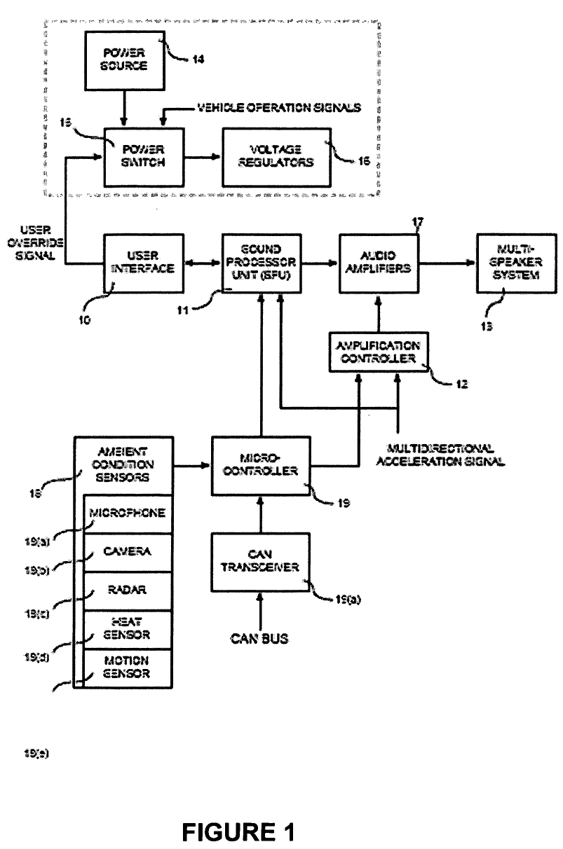

FIG. 1 is a schematic diagram of the sound emitting system. As shown in FIG. 1, a user interface 10 is installed at a predetermined position in the vehicle and/or carried on the driver. This user interface, which could be but is not limited to a USB or cable or wireless or customized port, is used by the driver or vehicle technician to install new sounds. The user interface can also used by the driver to set sound preferences. The user interface can have graphic components, e.g. LED indicators, LCD display, etc and may also include mechanical, electromechanical or visual components including, but not limited to knobs, buttons speech recognition and/or an interactive screen. The user interface may perform/provide features including but not limited to turning the sound off, switching sound files, adjusting volume, switching between a “urban,suburban,rural,racetrack” modes with different system and sound profiles, setting peripheral sounds for vehicle operations such as doors opening or closing, hood/trunk opening closing, start-up sounds, engaging or disengaging active noise control and/or engaging disengaging high frequency sounds.

The user interface may be connected to and communicate with a sound processor unit (SPU) 11, which is also installed in a predetermined position in the vehicle and is protected mechanically to prevent tampering. For example, the sound processing unit 11 may be protected by lock and key mechanism or in a sealed casing. The sound processing unit 11 may also be protected by a break seal to hide the electric components from hacking, e.g. metal, plastic, or other material. The SPU 11 may be implemented using digital signal processors, microcontrollers, audio CODEC, memories, audio A/D and D/A converters and/or filters. In one implementation, the microcontroller could also be replaced by field programmable gate array (FPGA). In one implementation, the microcontroller may be a commercially available Microchip PIC or dsPIC microcontroller.

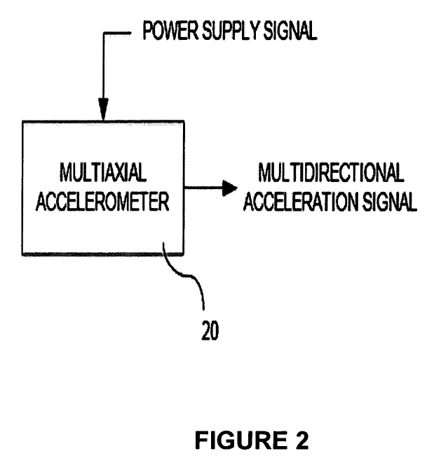

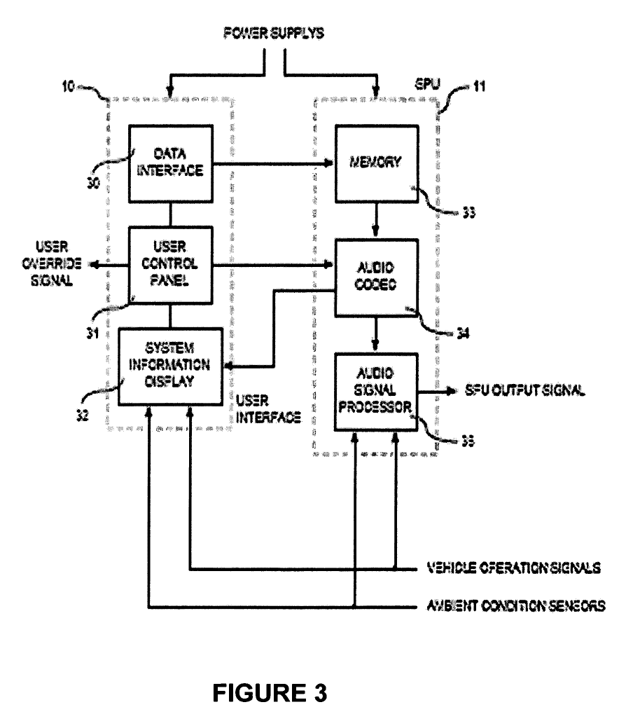

The SPU stores (in a memory that is part of the SPU or separate from the SPU) one or more sound files, generates the signals that can be amplified and fed into a set of speakers 13 to play the one or more sound files and can be used to modify encrypted sound files, as well as integrates multidirectional acceleration signals (see FIGS. 2 & 3) and vehicle operation signals (see FIG. 3). The SPU reads the acceleration/vehicle operation signals and performs the sound algorithm accordingly by selecting the sound and modulating the sound loudness and spectrum (frequencies). The SPU 11 then sends signals to one or more audio amplifiers 17 which are well known devices/circuits which then feeds the amplified signals into the multiple speaker system 13 which generates a sound based on the amplified signals and then emits the sounds. The multiple sound speaker system 13 may have a plurality of speakers located at different locations in the vehicle. For example, the multiple sound speaker system 13 may have one or more speakers in the front of the vehicle facing forward, one or more speakers in the rear of the vehicle facing behind the vehicle, one or more speakers on the left side of the vehicle and one or more speakers on the right side of the vehicle. Speakers may also be located in the interior of the vehicle and still project sounds to the exterior. In addition to the speakers 13 (or instead of the speakers 13), the sound system may include a mechanical sound emitting device or an actuator.

A microcontroller 19 shown in FIG. 1 that is coupled to the amplifier controller 12 And the SPU 11 may operate as central control unit and may control the operations of both the SPU 11 and the amplifier controller 12. The system may also include one or more ambient condition sensors 18, which may include, for example, a microphone 18a that generates signals indicating the ambient conditions of the vehicle at the time that the sound is to be generated. For example, the ambient condition sensors may include other sensors that detect pedestrian locations and/or structure locations and adjusts the sound loudness and projection accordingly. The one or more ambient condition sensors 18 may also sense the condition of the environment of the vehicle which includes but not limited to pedestrians or other factors outside of the vehicle which are subsidiary users and who carry with them a device to produce a signal which adjusts the loudness and/or character of the sound signal.

As shown in FIG. 1, the one or more ambient condition sensors 18 may include an image sensor 18b, such as a camera, for visual detection of pedestrians or structures, a electromagnetic wave sensor 18c, such as radar, for detecting pedestrian or structure locations, a electromagnetic sensor 18d, such as a heat sensor, for detecting pedestrian or structure locations, or a motion sensor 18e for detecting motion. The ambient condition sensors may include other sensors such as an altimeter, a humidity sensor, an anenometer, a temperature sensor, an electromagnetic sensor and/or a radiofrequency emission sensor. The signals from the one or more ambient sensors 18 are fed to a microcontroller 19 and then through an amplification controller 12. In one implementation, a commercially available Microchip PIC18F4580 microcontroller may be used. The output from the amplification controller may be fed into the audio amplifier 17 which controls the audio amplifier and adjusts the amplification based on the ambient conditions and the modified amplified signals and then fed to the multiple speaker system 13, although it is possible that the SPU 11 may be accessed during this process. For example, if the ambient condition sensors indicate a loud ambient condition, then the amplification may be increased so that the volume of the sounds emitted by the speakers 13 is increased to compensate for the loud ambient environment. As another example, if the ambient condition sensors indicate a very quiet ambient condition, then the amplification may be decreased so that the volume of the sounds emitted by the speakers 13 is reduced to compensate for the very quiet ambient environment. The ambient condition sensors 18, such as the microphone 18a, also may be to record environmental sounds for unspecified uses or to triangulate sirens or other noises. As another example, the ambient condition sensor 18, such as a microphone 18a, may be used in conjunction with a SPU 11 or another separate microprocessor control to determine if any speaker is malfunctioning and failing to produce sound or producing incorrect sounds based on expected signal outputs. This “reflex” feature would allow the system to shut off or modify the function of a speaker if the speaker behavior is abnormal, thus providing an extra level of optimal control and potentially minimizing unexpected adverse sound emission which may occur as a result of weather conditions, electromagnetic disturbances, physical damage such as that incurred in a motor vehicle accident or other causes.

In one embodiment, the sound system may be powered by a power source 14, such as a vehicle battery, although subsidiary batteries may be used, and is controlled by a power switch 15. One or more voltage regulators 16 provide appropriate power supplies for the various system components as shown. The system may also include a user override signal (triggered by the user through the user interface) that allows the user to shut down the sound emitting system. The power switch 15 may also receive vehicle operation information that can be used to control the power switch. When the vehicle is in non-operational status, the power switch reads such information and turns off the system to avoid power dissipation. The sound system, instead of being powered by the vehicle battery 14, may be powered by alternative sources, such as solar panels and/or a separate battery.

The controller 19 that receives the one or more ambient condition sensors 18 may also be connected to a well known CAN bus through a CAN transceiver 19a. The CAN bus signals may then be fed into the controller 19 and onto the SPU 11 and the amplification controller 12. The CAN bus is well known and can be used to obtain various vehicle operation signals.

The sound system may also have circuitry and software that permits the sound system to gather information about the vehicle motion and then generate the appropriate sounds using the appropriate speakers as will now be described in more detail. In addition to the accelerometers and the other vehicle sensors, the sound system may utilize various sensors and device to determine the vehicle motion or the intent of the driver of the vehicle. The sound system shown in FIG. 1 may also be integrated with car alarms or horns or other warning devices. In the implementation shown in FIG. 1, the SPU 11 may be separate from the vehicle computer system, but the SPU 11 may also be integrated into the vehicle computer system.

FIG. 2 is a diagram of a multiaxial accelerometer 20 whose output (a multidirectional acceleration signal(s)) is fed to the SPU 11, amplification controller 12 and/or the multiple speaker system 13. The multiaxial accelerometer(s), in combination with information from the vehicle computer or standing alone, generate signals that indicate a direction of motion of the vehicle and the acceleration of the vehicle and thus and allows the sound system to determine/select which speaker(s) of the speaker system 13 to engage to emit the sound in the appropriate direction based on the motion and the acceleration of the vehicle. For example, if the car is moving in reverse, the front facing speakers project less sound than the rear speakers. Also, for example, if the vehicle is turning left, the speakers on that side will project more loudly than those on the right.

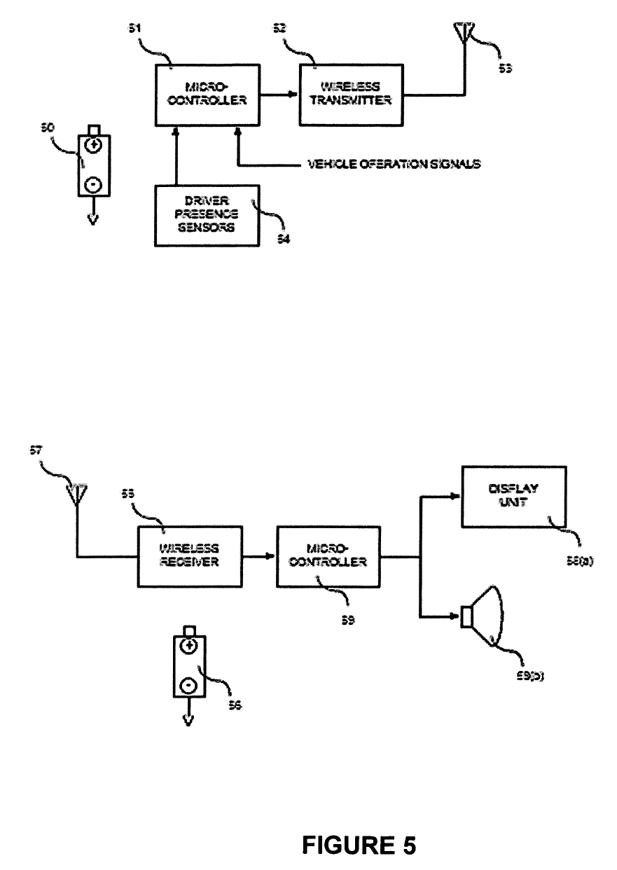

FIG. 3 is a diagram of the user interface 10 and the sound processor unit (SPU) 11. The user interface 10 has a data interface 30 which consists of a user control panel 31 and system information display 32. The user control panel may consist of an interactive module which includes LED backlit buttons or other appropriate interfaces. The data interface may also include a remote component, illustrated later in FIG. 5. The SPU 11 consists of electrical processors, including a memory 33 for sound file storage, an audio codec 34 and an audio signal processor 35 that may include both a DSP and an ASP) that may output the data from the SPU 11. Alternatively, the user control panel 31 may have a broad range of interactive methodology, including voice, ID recognition, wireless networking, etc. The user control panel may include portable devices utilized by individuals outside the vehicle that transmit signals to the system to modify system functionality. For example, a blind individual could carry a portable user interface which would transmit a signal to the system and modify system outputs and sound profiles. This user interface includes specialized wireless devices or common devices such as cell phones, etc. The SPU 11 has the capacity to store one or multiple files and may possess special architecture which allows sound files to be recapitulated slightly differently in order to prevent attenuation to the sounds on the part of those intended for the acoustic cues. In addition, the SPU 11 and system information display 32 can receive vehicle status inputs from the vehicle computer or other components (such as the multidirectional acceleration signals) and these signals are used by the SPU 11 and system information display 32 to determine sound profiles. The vehicle status inputs may include but are not limited to speed, rpm, forward versus reverse, on or off, idle or engaged, brake engaged or released, etc.

The system may include one or more sound profiles that represent different sounds of the vehicle. The system may also have one or more sound suites wherein each sound suite may have a plurality of sound profiles. For example, one sound profile may simulate a particular type of car noise, etc. . . . Each sound profile may have various properties (unique or not) such as periodicity, frequency range, pitch, tone, timbre, beat, etc. As an example, each sound suite of the system may have one or more vehicle operations sounds that may include, but are not limited to, a start-up sound, a combustion engine status (on/off, etc.), an electric motor status (on/off, rpm, etc.), drive mode sounds (Park, Drive, Reverse, Neutral and or Cruising), a speed sound, a turning projection sound, a steering wheel position, a side-ways acceleration sound, an acceleration/deceleration, a tachometer/Engine RPM sound, a pedal position, a accelerometer sound and/or a battery recharging/regenerative breaking sound. As another example, each sound suite of the system may have one or more vehicle status sounds that may include, but are not limited to, a vehicle locked/unlocked sound, a doors opening/closing sound, a hood opening/closing sound, a trunk opening/closing sound, a gas door opening/closing sound, a sunroof open/closed sound, a parking brake engaged/disengaged sound, a windows opening/closing sound, an external light status and functioning sound, an internal light status and functioning sound, a seat belt status sound, a gas filling indicator sound, a low gas level sound, a battery level indicator sound, a vehicle system/malfunction warning sound, a climate control status and functioning sound, a gear shifting up/down sound, a windshield wiper status and functioning sound, a cruise control status and functioning sound, a handsfree phone activated/deactivated sound, a key in/out sound, a spare tire installed/uninstalled sound, an ABS activated/deactivated sound, a vehicle dynamic control (VDC) status sound and/or a system maintenance sound.

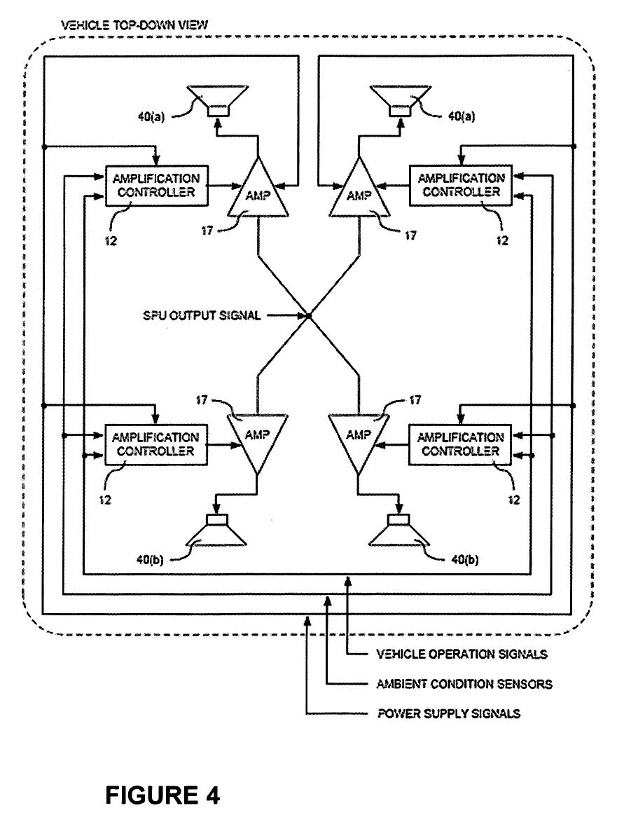

FIG. 4 is a depiction of the multiple speaker system 13, including speakers 40 in a four point configuration, installed in fixed positions which will likely be in the front and rear wheel wells. As shown in FIG. 4, the system may include one or more front speakers 40a and/or one or more rear speakers 40b. Each speaker 40 is individually controlled by an amplifier 17 that is associated with each speaker. The amplifier itself is controlled by the SPU 11 output signal as well as the amplification controller 12. Each speaker has the capability of emitting sound independently of the other speakers, dependent upon vehicle status such as motion in a certain direction, etc. Each speaker may include a special customized component which allows them to be affixed into the vehicle body, as well as a special design which allows the speakers to project out of the vehicle body. It is possible that a speaker that is exposed may have a wiper blade or self-cleaning mechanism.

FIG. 5 is a diagram of the remote driver display. A wireless transmitter 52 is powered by its own battery 50 which may be recharged off of the vehicle battery and is ultimately regulated by a microcontroller 51. The wireless transmitter 52 sends a signal via a transmitter antennae(s) 53 to a remote speaker or sound actuator or display 58a on a wireless receiver 55 with a battery 56 and a microcontroller 59, including but not limited to a customized device or the driver's cell phone or Bluetooth connected equipment. The wireless receiver will likely require a receiver antennae 57. The wireless transmitter 52 serves to inform the driver of the vehicle's status, particularly if there is evidence that the driver is no longer in the vehicle when the vehicle has been left on. For example, this may be accomplished through a set of driver presence sensors 54, which may include but is not limited to a driver's seat pressure sensor or a link to the driver's side seat belt status sensor or an optical or thermal sensor.

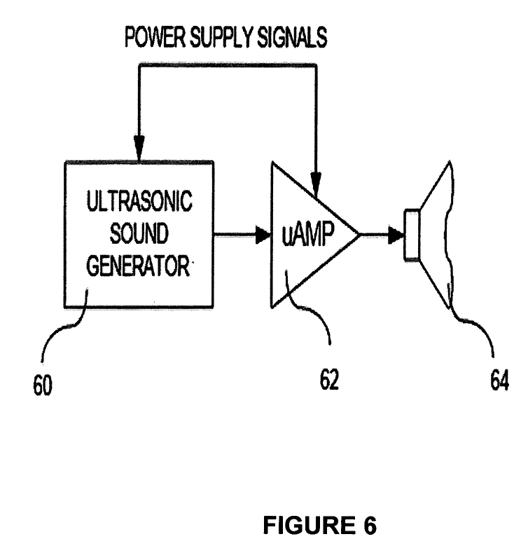

FIG. 6 is a diagram of the ultrasonic emission component subsystem. In this embodiment, the multiple speaker system 13 has an ultrasonic sound subsystem which includes an ultrasonic sound generate 60 which controls an ultrasonic amplifier 62 which, in turn, feeds into the ultrasonic/specialized speaker 64. These speakers are capable of emitting ultrasonic bursts when a car is initially started or idling or about to move, as well as other conditions in which ultrasonic bursts may serve as a cue to animals or human beings.

The sound generating system thus provides acoustic cues to those outside of quietly-operating vehicles (hybrid, electric motor, fuel cell, etc.). The system may permit a driver of a vehicle or a technician can modify the sound files and operating preferences of the external vehicle sound system. For example, a driver may prefer the emission of one sound on one day and another sound on another day and may be able to switch between them. Likewise, a driver may want ultrasonic bursts emitted when the parking brake is disengaged or at another time, in order to make animals or children aware of the driver's intent.

In most embodiments, the sound system may be activated when the car is turned on. When the car is turned on, the sound system may emit an idling sound. When the driver wishes to accelerate, the sound system emits acoustic cues in an appropriate manner. For example, a driver who is backing out of a garage will cause the external sound system to produce sounds in the rear of the vehicle, indicating that the vehicle is backing up. At slow speeds, the external vehicle sound system may have the capacity to weigh conditions and adjust volume, pitch, timbre, and/or projection. However, the operating mode may depend upon the driver and/or technicians preferences. While moving at low speeds, the sound system will emit acoustic cues. Once speeds/conditions no longer require the sound system to be active, then the system may shut off, a feature distinct from prior art. It is possible that the sound system could be used to emit warning or alarm sounds or can be used as a general speaker under very restricted circumstances, although this is a secondary consideration and not the primary intent. In addition, when the vehicle is active and the driver's door is shut, the external sound system may emit a sound to notify those around the vehicle that the vehicle may move. If the driver has accidentally or otherwise left the vehicle while it is running, the sound would serve to notify the driver that the vehicle is operational. In addition, the remote display device and wireless transceivers may also serve to inform the driver that they have left the vehicle operational or possibly in a precarious state as determined by the driver's presence sensor.

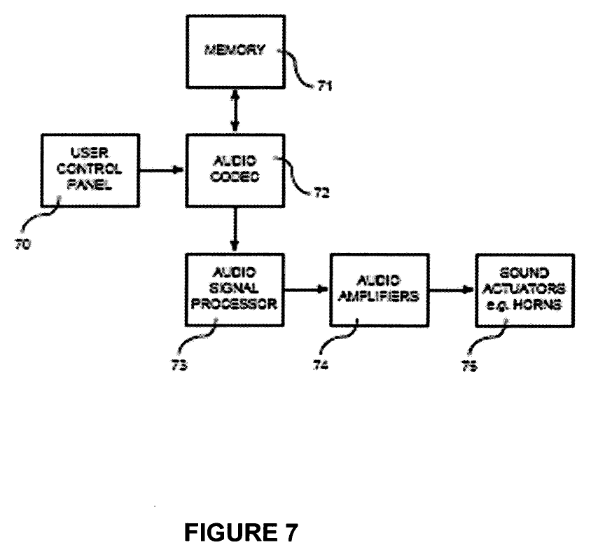

FIG. 7 illustrates another embodiment of the system to give out a warning in a more pleasant and effectively way which is a customized horn that a driver can press a button to activate. The driver can also choose different horns in different situations. The system has a user interface 70, such as push buttons, touch screen, rotary switch, etc., that allows the user to control the system. The user interface is coupled to an audio codec 72 that, based on the input at the user interface portion 70, loads a sound file from a memory 71 (that may store one or more different horn sound files) and decodes the horn sound file. Au audio signal processor 73 may receive the decoded horn sound file and process the horn signal and output a digital signal corresponding to the horn signal to an audio amplifier 74 that amplifies the horn signal to the appropriate decibel level and then outputs it to the one or more sound actuators 75, such as speakers, horns, etc., that generate the user requested horn sound.

While the sound generation system can be used to provide the driver with acoustical cues and/or provide feedback to the driver. However, if the driver chooses to avoid use of the external sound system cues, soundproofing strategies can be employed.

The sound system may also be operated such that, at low speeds, sound is emitted to provide acoustic cues to pedestrians, cyclists, animals and others and, at high speeds (>15,>25 or >35 mph), the sound emitting system in coordination with a microphone and processing system produces sound waves to cancel out or suppress mechanical and road noise to reduce the overall noise produced by the vehicle. For example, one possible example is that two microphones are placed behind the front wheel wells and they capture noise generated by the wheels, send a signal to a processor which integrates and sends a signal to nearby speakers which emit noise that cancels the noise generated in the front of the car, this reducing the overall noise emitted by the vehicle.

The sound system may also use fans or a suitable alternative to emit sounds to serve as acoustic cues at low speeds, but at higher speeds, the system would convert and the components would be used in part to capture wind and air current that occurs with the vehicles motion to recharge the vehicle battery.

While the foregoing has been with reference to a particular embodiment of the invention, it will be appreciated by those skilled in the art that changes in this embodiment may be made without departing from the principles and spirit of the invention, the scope of which is defined by the appended claims.

1. A vehicle sound generation system, comprising:
a power source;
a sound unit coupled to the power source that, based on a sound file, generates electrical signals corresponding to the sound file when a particular operation of the vehicle occurs; and
a sound generator that generates a sound signal based on the electrical signals that is emitted external to the vehicle that corresponds to the particular operation of the vehicle.

2. The system of claim 1 further comprising one or more ambient condition sensors that sense a condition of an environment of the vehicle that adjust the loudness and/or character of the sound signal based on the condition of the environment of the vehicle.

3. The system of claim 2, wherein the one or more ambient condition sensors further comprises a microphone.

4. The system of claim 2, wherein the one or more ambient condition sensors further comprises a sensor that detects pedestrian location or structure locations around the vehicle.

5. The system of claim 4, wherein the sensor further comprises an image sensor, an electromagnetic wave sensor, an electromagnetic sensor or a motion sensor.

6. The system of claim 2, wherein the one or more ambient condition sensors further comprises an altimeter, a humidity sensor, an anenometer, a temperature sensor, an electromagnetic sensor or a radiofrequency emission sensor.

7. The system of claim 1 further comprising a vehicle status unit that communicates a vehicle status signal to the sound unit wherein the vehicle status signal indicates a vehicle state.

8. The system of claim 7, wherein the vehicle status unit further comprises an interface to a CAN bus that receives a plurality of vehicle status signals from a plurality of vehicle sensors.

9. The system of claim 7, wherein the vehicle status unit further comprises an accelerometer.

10. The system of claim 1 further comprising an amplifier coupled to the sound generator that amplifies the electrical signals corresponding to the sound file.

11. The system of claim 10 further comprising an amplifier controller that controls the amplification of the amplifier.

12. The system of claim 1, wherein the sound generator further comprises one or more speakers in a front portion of the vehicle and/or one or more speakers in a rear portion of the vehicle and wherein the sound unit further comprises a sound controller that distributes the sound signal to the one or more front speakers and the one or more rear speakers.

13. The system of claim 12, wherein the sound controller distributes the sound signal to only the one or more rear speakers.

14. The system of claim 12, wherein the sound controller distributes the sound signal to only the one or more front speakers.

15. The system of claim 1 further comprising a user interface portion that allows a user of the vehicle to control the sound signal.

16. The system of claim 15, wherein the user interface portion further comprises a knob, a touch screen, switch or a dial.

17. The system of claim 1, wherein the sound generate further comprises a horn, an ultrasonic device or a mechanical device.

18. The system of claim 1 further comprising a memory that stores one or more sound files.

19. The system of claim 1 further comprising a vehicle into which the power source, the sound unit and the sound generator are installed.

20. The system of claim 19, wherein the vehicle further comprises a hybrid vehicle, an electric motor, an electric vehicle, a fuel cell vehicle, a bicycle, an electric motorcycle, a moped or a scooter.

21. The system of claim 1, wherein the power source further comprises a vehicle battery or solar energy or wind regeneration.

22. A method for generating a vehicle sound, comprising:
providing at least one sound file;
generating, in a sound unit, electrical signals corresponding to the sound file when a particular operation of the vehicle occurs; and
generating a sound signal based on the electrical signals that is emitted external to the vehicle that corresponds to the particular operation of the vehicle.

23. The method of claim 22 further comprising sensing a condition of an environment of the vehicle that is used to adjust the loudness of the sound signal based on the condition of the environment of the vehicle.

24. The method of claim 22 further comprising detecting pedestrian location or structure locations around the vehicle that is used to adjust the loudness of the sound signal based on the pedestrian location or structure locations

25. The method of claim 22 further comprising amplifying the electrical signals corresponding to the sound file.

26. The method of claim 22, wherein generating a sound signal further comprises distributing the sound signal to the one or more front speakers and the one or more rear speakers.

27. The method of claim 22, wherein generating a sound signal further comprises distributing the sound signal to one or more rear speakers.

28. The method of claim 22, wherein generating a sound signal further comprises distributing the sound signal to one or more front speakers.

29. The method of claim 22 further comprising storing one or more sound files.
